(19) United States
(12) Patent Application Publication
(10) Pub. No.: US 2009/0110237 A1
(43) Pub. Date: Apr. 30, 2009

(54) METHOD FOR POSITIONING A NON-STRUCTURAL OBJECT IN A SERIES OF CONTINUING IMAGES

(75) Inventors: Ko-Shyang Wang, Kaohsiung City (TW); Po-Lung Chen, Taipei City (TW); Chih-Chang Chen, Kaohsiung City (TW)

Correspondence Address: WPAT, PC, 7225 BEVERLY ST., ANNANDALE, VA, 22003, US

(73) Assignee: INDUSTRIAL TECHNOLOGY RESEARCH INSTITUTE, Hsin-Chu (TW)

(21) Appl. No.: 11/966,707

(22) Filed: Dec. 28, 2007

(30) Foreign Application Priority Data
Oct. 25, 2007 (TW) 096140013

(51) Int. Cl. G06K 9/00

(52) U.S. Cl. 382/103

(57) ABSTRACT

A method for positioning a non-structural object in a series of continuing images is disclosed, which comprises the steps of: establishing a pattern representing a target object while analyzing the pattern for obtaining positions relative to a representative feature of the pattern; picking up a series of continuing images including the target object for utilizing the brightness variations at the boundary defining the representative feature which are detected in the series of continuing images to calculate and thus obtain a predictive candidate position of the representative feature in an image picked up next to the series of continuing images; calculating the differences between the boundaries defining the representative feature at the predictive candidate position in the series of continuing images and also calculating the similarities between the pattern and those boundaries; and using the differences and the similarities to calculate and thus obtain the position of the representative feature in the image picked up next to the series of continuing images.

### FIELD OF THE INVENTION

The present invention relates to a method for positioning a non-structural object in a series of continuing images, and more particularly, to a method for positioning a target object which first establishes an initial pattern of the target object using a series of continuing images and then obtains and defines a searching area in an image picked up next to the series of continuing images by a proposed tracking algorithm in which similarities between the pattern and those boundaries defining representative features of candidates moving in the series of the continuing images are calculated and thereafter compared so as to identify the position of the target image.

### BACKGROUND OF THE INVENTION

In human machine interactions, it is known that most human activities are not as highly detectable and identifiable by image processing as by the use of wearable contact sensors. Moreover, as the identification using image processing will require a lot more memories and longer processing time, instant response for interaction by image processing may not be achieved as simple as by other sensors. Since tracking a target using image processing are easily being interfered by many variables, such as background, noises, light variations, etc., currently a good identification using image processing usually require the target to be captured by more than one video cameras as well as to be sensed by other sensing components by assisting the image processing, or to be filmed in a simply background.

There are many studies for improving the identification using image processing. One such study is a hand pointing method, disclosed in U.S. Pat. No. 6,464,255, entitled “Hand pointing apparatus”. However, the identification using the aforesaid apparatus is based upon an image which represents a 3-D space containing a target object, and an image of the target object picked up by at least two video cameras from different directions.

Another such study is a hand pointing method, disclosed in U.S. Pat. No. 6,600,475, entitled “Single camera system for gesture-based input and target identification”. The aforesaid study can track a target object by the use of only one video camera, which tracks the target object by geometric relationships and is required to establish four reference points before tracking.

Another such study is a hand pointing method, disclosed in U.S. Pat. No. 7,178,913, entitled “Vision-based pointer tracking and object classification method and apparatus”. Basically, the aforesaid method first narrows the area where a target object is most likely to be present by a robust tracking algorithm, and then uses a predictive proceeding to track the path of the target object, and finally locate the position of the target object by classification.

Another such study is disclosed in TW Pat. No. 911181463, which is a visual-based input device capable of direct a cursor to move according to the pointing of a user's hand. The aforesaid device is configured with two imaging devices, one for detecting horizontal movements of the user's hand while another for detecting vertical movements of the same, that is only usable for locating the position of the user's hand.

Yet, another such study is disclosed in TW Pat. No. 95217697, which is another visual-based input device capable of direct a cursor to move according to the pointing of a user's hand. However, it is required for the user to wear an indicator, such as a ring, to be used as a tracking target. That is, the aforesaid study can only track the movement of an object attached with such indicator.

Therefore, it is in need of a method that can interact with machine in a most nature manner by the use of least interfacing devices, and can rapidly track an object of arbitrary shape without being attached by any indicators or sensors.

### SUMMARY OF THE INVENTION

The object of the present invention is to provide a method for positioning a non-structural object in a series of continuing images, for enabling a user to interact with a machine in a most nature manner by the use of least interfacing devices without having the user to go through a tedious training process, and without being attached by any indicators or sensors for rapidly tracking and positioning an object of arbitrary shape, i.e. an non-structural object.

To achieve the above object, the present invention provides a method for positioning a non-structural object in a series of continuing images, comprising the steps of: establishing a pattern representing a target object while analyzing the pattern for obtaining positions relative to a representative feature of the pattern; picking up a series of continuing images including the target object for utilizing the brightness variations at the boundary defining the representative feature which are detected in the series of continuing images to calculate and thus obtain a predictive candidate position of the representative feature in an image picked up next to the series of continuing images; calculating the differences between the boundaries defining the representative feature at the predictive candidate position in the series of continuing images and also calculating the similarities between the pattern and those boundaries; and using the differences and the similarities to calculate and thus obtain the position of the representative feature in the image picked up next to the series of continuing images.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a flow chart illustrating steps of a method for positioning a non-structural object in a series of continuing images according to an exemplary embodiment of the invention.

FIG. 2 is a schematic diagram showing an architecture used in the invention.

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

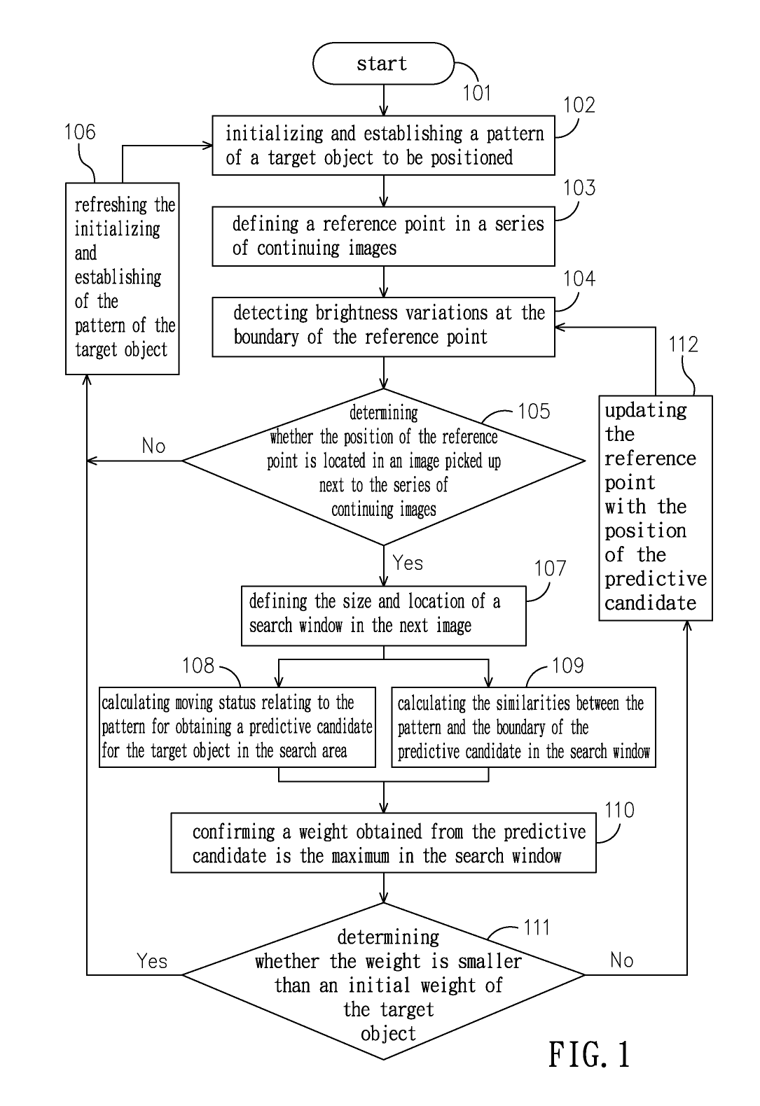

Please refer to FIG. 1, which is a flow chart illustrating steps of a method for positioning a non-structural object in a series of continuing images according to an exemplary embodiment of the invention. As shown in FIG. 1, the flow starts from step 101 which will be described step by step hereinafter.

Step 101: a location tracking procedure using the method of the invention is initiated.

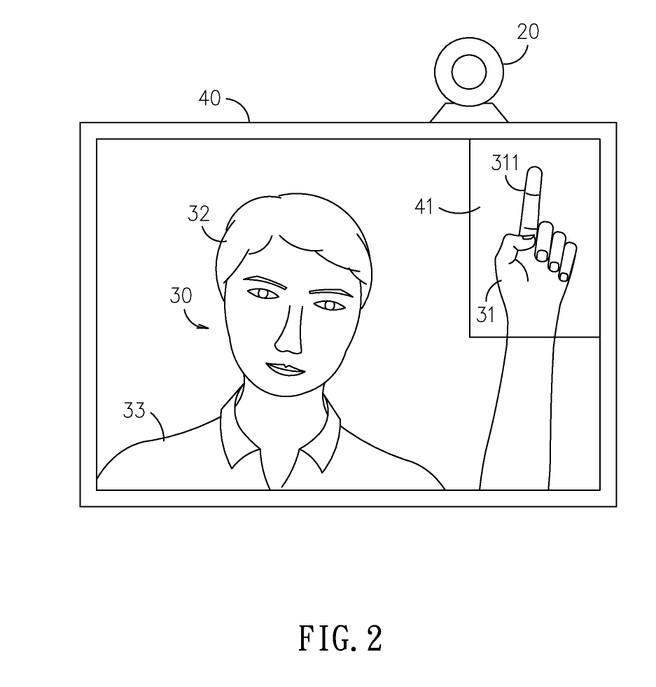

Step 102: a pattern of a target object to be positioned is initialized and established. Please refer to FIG. 2, which is a schematic diagram showing an architecture used in the invention. In FIG. 2, the image of a user 30 is captured by an imaging device 20 and then is displayed on a displaying device 40. Moreover, the displaying device is configured with a specific window 41, which is provided for the initialization of the target object. As shown in FIG. 2, a hand 31 with a pointing index finger 311 is specified to be the target object to be positioned, so that the user will intentionally place his hand 31 in the specific window 41. Thereby, representative features of the hand 31 can be analyzed and thus used as the pattern while designating an initial weight thereto.

Step 103: a reference point is defined on the target object, i.e. the hand 31 with the pointing index finger, and the brightness of the reference point is register for tracking. The defining of the reference point is dependent upon actual need that is usually at the most notable portion of the profile of the target object. In FIG. 2, the reference point will be the tip of the index finger 311.

Step 104: the brightness variations at the boundary of the reference point are detected, which includes the detection of gray-level gradient variations at the boundary, using which the coordinate of a position with brightness most resemble to that of the reference point can be obtained.

Step 105: if the coordinate of a position with brightness most resemble to that of the reference point is obtained, the original coordinate of the reference point is replaced by the newly acquired coordinate, i.e. the original reference point is replaced by the new reference point; otherwise, the location tracking procedure fails.

Step 106: if the location tracking procedure fails, that is, the position of the reference point is nowhere to be found in an image picked up next to the series of continuing images, the flow will proceed back to step 102 for restarting the establishing of the pattern. It is noted that the fail of the location tracking procedure may be caused by various factors, such as acute ambient brightness variation, the shape of the target object changes drastically, and so on.

Step 107: if the position of the reference point is located in an image picked up next to the series of continuing images and the original reference point is replaced by the new reference point, the size and location of a search window is defined in the next image with respect to the new reference point. Thereby, area in the next image that requires to be searched is reduced, and thus improves the effectiveness of the method as searching time can be reduced.

Step 108: moving status relating to the pattern is calculated for obtaining a predictive candidate of the target object in the search window. Relative to the background or other objects in the image such as the user's head 32, torso 33, or windows, furniture, etc., the hand 31 with the pointing index finger 311 must be the object in image that has maximum movement. Therefore, in order to located the target object in the next image, it is intended to find a position with maximum movement to be designated as the predictive candidate of the target object.

Step 109: the similarities between the pattern and the boundary of the predictive candidate in the search window are calculated and then the one with best similarity is selected. Taking the hand 31 with the pointing index finger 311 shown in FIG. 2 for example, the feature of its boundary will remain almost the same as that of the initial pattern even when the index finger 311 is bended during the movement, or the included angle between the index finger 311 and the had 31 is changed. In another word, it is important to select a target object whose shape is not going to change drastically during the location tracking procedure before establishing the pattern of the target object in the step 102.

Step 110: from the predictive candidates in the search window, one with maximum weight based upon the movement and boundary features is selected.

Step 111: an evaluation is being made for determining whether the weight is smaller than an initial weight of the target object; if so, the location tracking procedure fails and the flow proceeds back to step 106 and then back to step 102.

Step 112: if the selected weight is larger than the initial weight, the reference point with the position of the predictive candidate is used and thus the position of reference point is updated.

In conclusion with respect to the foregoing flow chart, the method for positioning a non-structural object in a series of continuing images comprises the steps of:
A. establishing a pattern representing a target object while analyzing the pattern for obtaining positions relative to a representative feature of the pattern; in which the front view of the target object is first being obtained by performing a filtering operation upon the series of continuing images and then the obtained front view is used for establishing the pattern; and the establishing of the pattern further comprise the step of: calculating and obtaining boundary information relating to the target object at positions where brightness and color variations in the series of continuing images are comparatively larger, so as to be used for optimizing the establishing of the pattern.
B. picking up a series of continuing images including the target object for utilizing the brightness variations at the boundary defining the representative feature which are detected in the series of continuing images to calculate and thus obtain a predictive candidate position of the representative feature in an image picked up next to the series of continuing images; in which the brightness variations at the boundary defining the representative feature being utilized for obtaining the predictive candidate position include gray-level gradient variations at the boundary.
C. calculating the differences between the boundaries defining the representative feature at the predictive candidate position in the series of continuing images and also calculating the similarities between the pattern and those boundaries; in which the calculating of the differences between the boundaries defining the representative feature at the predictive candidate position in the series of continuing images further comprises the step of: analyzing and calculating moving statuses of the target object in the series of continuing images while representing the difference by weighting; and the calculating of the similarities between the pattern and those boundaries further comprises the step of: re-establishing the pattern of the target object the same time when the series of continuing images is picked up and used for calculating the predictive candidate position of the representative feature in the next image.
D. using the differences and the similarities to calculate and thus obtain the position of the representative feature in the image picked up next to the series of continuing images; in which the calculating of the position of the representative feature in the next image includes the step of: using a weight for representing the accumulated effect of the differences and similarities for obtaining the position of the representative feature in the next image.

To sum up, the present invention provides a method that can interact with machine in a most nature manner by the use of least interfacing devices, and can rapidly track an object of arbitrary shape without being attached by any indicators or sensors. It is noted that the method of the invention can be adapted for various industry that only a few is named in the following:
(1) Toy related industry: As the method uses only one video camera, it is ease to be adapted for toys with miniature size and thus enables such toys to see gestures of a user and response accordingly. In addition, for home entertainment, as the one video camera configuration make the method ease to be adapted for device mounted on screen or game console, no drastic variation is required with respect to the home entertainment environment for installing the device.
(2) Sport and leisure related industry: Following the trend of adaptive personalization, the method enable arbitrary device to learn gestures of any user without having the user to go through a tedious training process.
(3) Interactive exhibition related industry: With the method of the invention, any interactive exhibition can be exhibited in an intuitive manner, that is, a user can control an interactive exhibition intuitively through the detection of non-contact sensors, thereby, the application of such interactive exhibition is expanded.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for positioning a non-structural object in a series of continuing images, comprising the steps of:
establishing a pattern representing a target object while analyzing the pattern for obtaining positions relative to a representative feature of the pattern;
picking up a series of continuing images including the target object for utilizing the brightness variations at the boundary defining the representative feature which are detected in the series of continuing images to calculate and thus obtain a predictive candidate position of the representative feature in an image picked up next to the series of continuing images;
calculating the differences between the boundaries defining the representative feature at the predictive candidate position in the series of continuing images and also calculating the similarities between the pattern and those boundaries; and
using the differences and the similarities to calculate and thus obtain the position of the representative feature in the image picked up next to the series of continuing images.

2. The method of claim 1, wherein in the establishing of the pattern, the front view of the target object is first being obtained by performing a filtering operation upon the series of continuing images and then the obtained front view is used for establishing the pattern.

3. The method of claim 1, wherein the establishing of the pattern further comprise the step of:
calculating and obtaining boundary information relating to the target object at positions where brightness variations in the series of continuing images are comparatively larger.

4. The method of claim 1, wherein the establishing of the pattern further comprise the step of:
calculating and obtaining boundary information relating to the target object at positions where color variations in the series of continuing images are comparatively larger.

5. The method of claim 1, wherein the step of picking up the series of continuing images is to capture the movement of the target object in the series of continuing images.

6. The method of claim 1, wherein the brightness variations at the boundary defining the representative feature being utilized for obtaining the predictive candidate position include gray-level gradient variations at the boundary.

7. The method of claim 1, wherein the calculating of the differences between the boundaries defining the representative feature at the predictive candidate position in the series of continuing images further comprises the step of:
analyzing and calculating moving statuses of the target object in the series of continuing images.

8. The method of claim 1, wherein the calculating of the differences between the boundaries defining the representative feature at the predictive candidate position in the series of continuing images further comprises the step of:
representing the difference by weighting.

9. The method of claim 1, wherein the calculating of the similarities between the pattern and those boundaries further comprises the step of:
re-establishing the pattern of the target object the same time when the series of continuing images is picked up and used for calculating the predictive candidate position of the representative feature in the next image.

10. The method of claim 1, wherein the calculating of the position of the representative feature in the next image includes the step of:
using a weight for representing the accumulated effect of the differences and similarities for obtaining the position of the representative feature in the next image.
